(19) United States
(12) Patent Application Publication
(10) Pub. No.: US 2003/0143033 A1
(43) Pub. Date: Jul. 31, 2003

(54) Process for providing an intercontinental power grid distribution system

(76) Inventor: William P. Cramer, Fort Walton Beach, FL (US)

Correspondence Address: Herman H. Bains, Attorney, 6101 Tracy Avenue, Minneapolis, MN, 55436, US

(21) Appl. No.: 10/056,494

(22) Filed: Jan. 28, 2002

(51) Int. Cl. E03F 3/06; F16L 1/06

(52) U.S. Cl. 405/184.4; 405/184; 405/154.1

(57) ABSTRACT

A process for providing a power grid distribution system using the interstate highway system and larger state highway systems for mass distribution of energy products including petroleum, gas, electricity, gasoline and fiber optics comprises the steps of placing energy product supply lines below the ground surface of median and adjacent right-of-way areas of interstate highways Each energy product supply line is connected to a source of the energy product. An outlet conduit is connected to lines each supply conduit and these outlet lines are located below the surface of the ground The outlet lines interconnect the supply lines with distributors and end users of the energy products.

### FIELD OF THE INVENTION

This invention relates to an intercontinental power grid distribution system and more particularly to distribution system using the interstate highway system for the mass distribution of energy products.

### BACKGROUND OF THE INVENTION

There is currently a need for an intercontinental power and distribution system for the efficient delivery of energy products to refiners and end users. Energy products such as oil and natural gas are distributed by privately owned producers and refiners by distribution lines which do not provide even and equitable distribution to end users. Electricity and fiber optics are also distributed by electrical power utilities and communication companies and sometimes these energy products distribution lines are not efficiently arranged.

### SUMMARY OF THE INVENTION

An object of this invention is to provide an intercontinental power grid distribution system which uses the interstate highway system and state highways having four to six lanes for locating the various energy product supply lines for efficiently supplying energy products to end users. In the preferred embodiment, the supply lines or conduits will be located below the ground surface in interstate highway median and in the areas immediately adjacent to highways. Supply lines may be placed below ground in the median and in the right-of-way areas adjacent both sides of the highway. The interstate highway system and the larger state highways includes both east-west highways as well as north-south highways therefore providing an effective distribution grid system

### BRIEF DESCRIPTION OF THE FIGURES OF THE DRAWINGS

FIG. 1 is a map of the United States illustrating some of the major interstate highways which run north-south or east-west;

FIG. 2 is a cross-sectional view of an interstate highway depicted as taken along line 2-2 of FIG. 1 and illustrating the proposed location of various supply lines for energy products, and

FIG. 3 is a plan view of a section of an interstate highway illustrating the typical arrangement of the power grid distribution system.

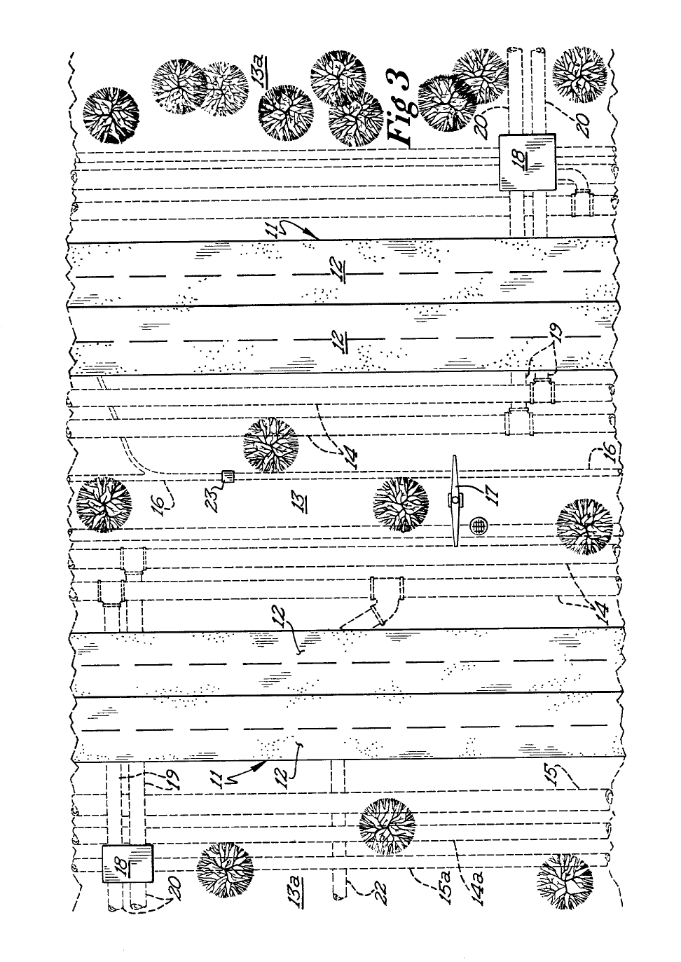

### DESCRIPTION OF THE PREFERRED EMBODIMENT

Energy products, such as petroleum, gas, electricity, and fiber optics, are controlled and distributed by private companies. The supply or distribution lines for these energy products do not follow efficiently designed geometrical patterns. For example, electrical energy products were produced and distributed at one time by public utility companies. The distribution patterns in many instances were determined by the state in which the utility company was located.

Petroleum and some petroleum products are usually distributed by pipelines to refineries where the crude petroleum is refined into various petroleum derived products Refined products such as gasoline are sometimes transferred from refineries by short pipelines to tank farms. The supply lines to the refineries have not followed the most efficient or equitable routes.

Telephone communications were at one time controlled by public utility companies and these lines were not always efficiently arranged. Telephone communications are transmitted by conventional electrical lines as well as fiber optic lines. All of these distribution systems can be adapted to the intercontinental power grid distribution system which use the interstate highway system.

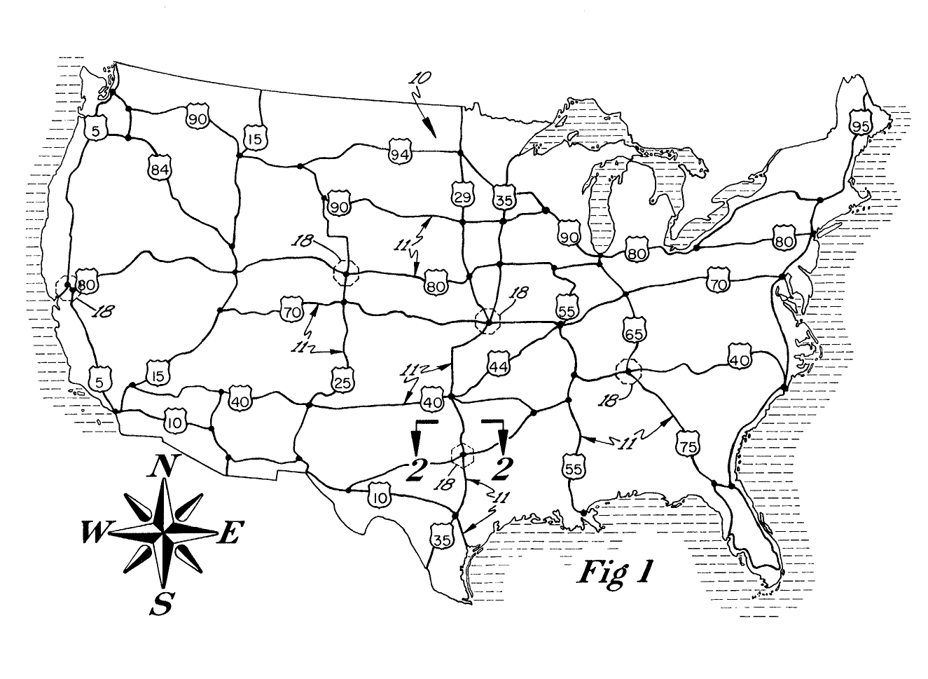

Referring now to the drawings and more particularly to FIG. 1, it will be seen that a map of the United States diagrammatically depicts the interstate highway system While the interstate highway system is not precisely shown, the map does give a general layout of the highway system It will be noted that the interstate highways run generally east and west or north and south. All of these highways are mostly divided highways having a dividing median area and right of way areas located at both sides of the highway. It is the median area and the right-of-way areas where the energy supply lines are to be located Larger state highways (4 to 6 lanes) may also be used to locate energy product supply lines.

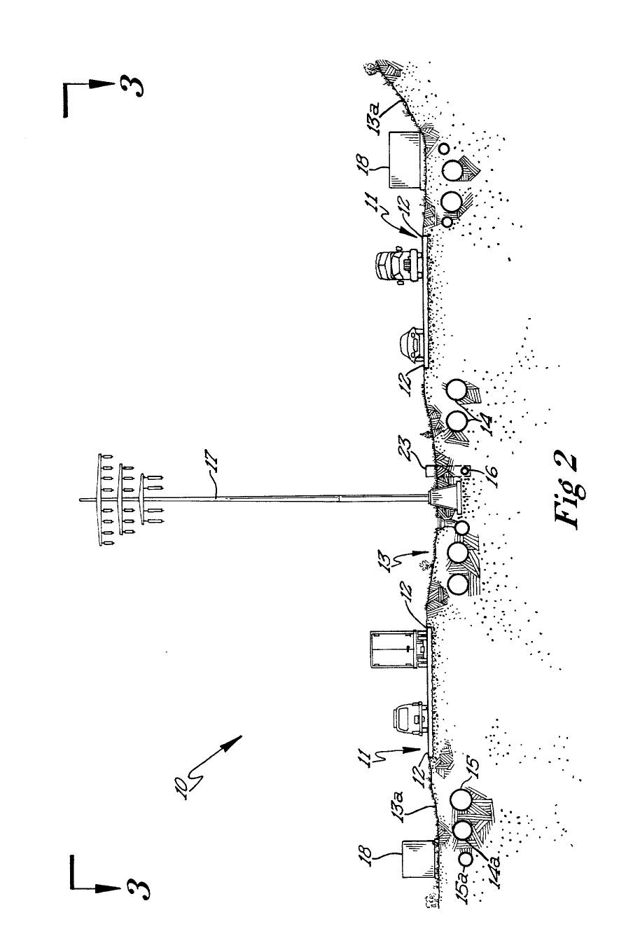

Referring now to FIG. 2, it will be seen that a cross-sectional view of an interstate highway showing the location of the various supply lines for various energy products is shown. The power and grid distribution system is designated generally by the reference numeral 10 in conjunction with an interstate highway 11 including highway lanes 12 and can accommodate several energy product supply lines. Similarly the right-of-way areas 13a located adjacent the outer margins of the highway can also accommodate a number of energy product supply lines.

In the embodiment shown, underground conducts 14 for transferring petroleum may be located in the median or in the right-of-way areas. In many applications, there maybe only one petroleum pipeline for supplying crude oil from a source to a refinery A conduit 15 or a plurality of such conduits for natural gas may also be located underground for transfer to a distributor.

Other types of energy product supply lines may also be provided including a conduit or conduits 14a for gasoline and a conduit or conduits 15a for aviation fuel. All of these energy product supply lines will be located underground in the median or right-of-way areas. A fiber optics line or lines 16 are also located underground and positioned within the median 13 or right-of-way areas 13a. Suitable poles 17 for high tension power lines may be located in the median area for conducting high voltage electrical current.

With respect to the supply lines for petroleum and other liquid energy products, it is necessary to provide pumping stations for the longer supply lines. In the embodiment shown, a pumping station 18 is provided and is located adjacent the interstate highway but at a sufficient distance to eliminate any safety problems caused by high speed vehicles that accidentally leave the highway.

A petroleum supply line 14 will be connected to the pumping station 18 by an inlet line 19 and will be returned to the supply line 14 by an outlet line 20. Such pumping stations will be located at porper distances for creating the desired pressure in the line.

The supply lines for the energy products will also be provided with outlet lines for supplying the energy products to intermediate or end users. For example, the petroleum supply line or lines 14 will be provided with an outlet line 21 which will be connected to the intake line or manifold of a refinery. Similarly, the gas supply line 15 will be provided with an outlet line 22 which will be connected to the inlet line or inlet manifold of gas tank farm. The owner of the gas tank farm is a distributor and usually will distribute gas to the end users.

It will be appreciated that a long transmission line for a fiber optic line will need a repeater for boosting transmission of the light signals. In the embodiment shown, a repeater 23 is provided in the fiber optic line 16 for boosting the fiber optic signal in a long transmission. All of the energy product supply lines will be provided with outlet lines for supplying the associated energy product to distributors or end users.

It is believed that the present power grid distribution system can progressively replace the system now in place. Leasing or pre-leasing of right-of-way access could be provided to private companies participating in this system. There would be no need for the exercise of eminent domain procedures or environmental impact studies in implementing this system Participating power companies may apply for joint application (federal and state) to develop new lines using this system. The new Geographic Information System may be used by participating power companies in implementing their respective energy product supply lines. New highways and energy systems being built together at the same time in the same path would lower environmental impacts fifty (50) percent since they would use fifty (50) percent less area.

The sizes of the supply lines, for example petroleum pipelines may be 36 inches in diameter or larger and may be piggybacked to provide for more lines The governing national codes for safety and the provision of buffer zones will, of course, be followed. Other energy supply lines may be of the conventional size or sizes as provided by the controlling codes. It will be appreciate that many of the end users will be located adjacent or reasonably close to an interstate highway. This proposed system therefore provides for efficient distribution of energy products

In addition to energy products, water and waste (carbon dioxide) may also be transported by pipelines using the present distribution system.

From the foregoing description, it will be seen that this distribution system permits efficient and equitable distribution of energy products by using the interstate highway system.

Another benefit is that our nation's energy system would be under constant protection by state highway patrol units who are already patrolling the interstate system.

This would help protect our new nation's energy system from terrorists attacks without raising extra security expenses. To our new system, if an attack occurred the valving would be already in place for re-routing this problem without disrupting the operation. The problem could be fixed promptly without having to fix huge environmental clean-up expenses. It is also more efficient since pipeline companies would not have to hire extra planes and security employees to patrol the new energy system which would be indirectly cheaper for the consumer.

What is claimed is:

1. A process for providing an intercontinental power grid distribution system using the interstate highway system for the mass distribution of energy products including petroleum, gas, electricity, gasoline, and fiber optics, comprising
placing energy product supply lines below the ground surface of the median of an interstate highway and the right-of-ways immediately adjacent the interstate highway, the energy product supply lines supplying energy products selected from the group consisting of petroleum, gas, gasoline, fiber optics and electricity,
connecting each supply line to a source of an energy product,
connecting each supply line to an outlet line extending at an angle below the ground such for supplying distributors and end users with an energy product.

2. The process as defined in claim 1 wherein the energy product is petroleum, providing pumping stations for each petroleum supply line and interconnecting each petroleum supply line to a pumping station for maintaining the pressure in the petroleum supply line.
